(19) United States
(12) Patent Application Publication
(10) Pub. No.: US 2025/0208896 A1
(43) Pub. Date: Jun. 26, 2025

(54) SEMICONDUCTOR DEVICE AND SWITCHING METHOD FOR OPERATING SYSTEM

(71) Applicant: Renesas Electronics Corporation, Tokyo (JP)

(72) Inventors: Yasumasa TONOSHITA, Tokyo (JP); Makoto UKAI, Tokyo (JP)

(21) Appl. No.: 18/944,270

(22) Filed: Nov. 12, 2024

(30) Foreign Application Priority Data
Dec. 25, 2023 (JP) 2023-217706

(51) Int. Cl. G06F 9/455

(52) U.S. Cl. CPC G06F 9/45558; G06F 2009/45583

(57) ABSTRACT

A semiconductor device includes a processor including a first register set and a second register set. In a first period, the processor selects the second register set as an active register set, and executes a first virtual machine by use of second context data. In a second period, the processor selects the first register set as the active register set, and executes a hypervisor by use of first context data. In the second period, the processor performs a processing of saving the second context data and a processing of reading third context data. In a third period, the processor selects the second register set as the active register set, and executes a second virtual machine by use of the third context data.

### CROSS-REFERENCE TO RELATED APPLICATION

The disclosure of Japanese Patent Application No. 2023-217706 filed on Dec. 25, 2023, including the specification, drawings and abstract is incorporated herein by reference in its entirety.

### BACKGROUND

The present disclosure relates to a semiconductor device and a switching method for an operating system.

There is disclosed a technique listed below.
[Patent Document 1] Japanese Unexamined Patent Application Publication No. 2021-76908

A virtualization technique for constructing a virtual machine (VM) on a physical machine has been known. The Patent Document 1 discloses a virtualization system for operating a plurality of operating systems (OS) on a virtual machine constructed by a hypervisor.

### SUMMARY

When an operating OS is switched on a virtualization system (virtualization environment) disclosed in the Patent Document 1, the hypervisor controls the switching of the virtual machine executing the OS. The switching of the virtual machine needs the processings of saving and reading context data. Specific processings to be performed are a processing of saving context data stored into a register set in a not-switched-yet processor and a processing of reading context data to be stored into a register set in a switched processor.

As described above, the switching of the virtual machine is controlled by the hypervisor, and thus, the processings of saving and reading context data in the switching of the virtual machine need not only the processings of saving and reading context data for execution of a plurality of virtual machines to be switched but also the processings of saving and reading context data for execution of the hypervisor. Generally, the context data is saved in a memory accessible from a processor, and thus, the processings of saving the context data for the executions of the virtual machines and the hypervisor from a register set into the memory and the processings of reading it from the memory into the register set are performed for each switching of the virtual machine (or OS). However, the memory access time required for the processings of saving and reading context data affects the processing time of the OS executed on the virtual machine, and thus, there may be a risk of failure to sufficiently exert the performance of the virtual machine due to such increase in the memory access time.

Other objects and novel characteristics will become apparent from the description of the present specification and the drawings.

A semiconductor device according to an embodiment includes a processor including a first register set and a second register set, and a memory storing a hypervisor therein. The first register set stores first context data therein. The second register set stores second context data or third context data therein. In a first period, the processor selects the second register set as an active register set, and executes a first virtual machine by use of the second context data. In a second period, the processor selects the first register set as an active register set, and executes the hypervisor by use of the first context data. In the second period, the processor reads the second context data, and stores it into the memory, and reads the third context data from the memory, and stores it into the second register set. In a third period, the processor selects the second register set as an active register set, and executes a second virtual machine by use of the third context data.

A switching method for an operating system according to an embodiment is a switching method for an operating system performed by a semiconductor device in which a first virtual machine and a second virtual machine operate. The semiconductor device includes a processor including a first register set and a second register set, and a memory storing a hypervisor therein. The first register set stores first context data therein. The second register set stores second context data or third context data therein. In the switching method for the operating system, in a first period, the processor selects the second register set as an active register set, and executes the first virtual machine by use of the second context data. In a second period, the processor selects the first register set as an active register set, and executes the hypervisor by use of the first context data. In the second period, the processor reads the second context data and stores it into the memory, and reads the third context data from the memory and stores it into the second register set. In a third period, the processor selects the second register set as an active register set, and executes the second virtual machine by use of the third context data.

According to the embodiment, the processings of saving and reading context data for execution of a plurality of virtual machines are performed on the background by use of a plurality of register sets including a register set which stores context data for execution of the hypervisor and a register set which stores context data for execution of the virtual machines. Thereby, the memory access time required for the processings of saving and reading context data can be hidden. Consequently, the time to execute the OS operating on the virtual machine can be increased, and the performance of the virtual machine can be improved.

### BRIEF DESCRIPTIONS OF THE DRAWINGS

FIG. 1 is a block diagram illustrating an exemplary configuration of a semiconductor device according to a first embodiment.

FIG. 2 is a timing chart illustrating the processings of saving and reading context data according to the first embodiment.

FIG. 3 is a block diagram illustrating an exemplary configuration of a semiconductor device according to a second embodiment.

FIG. 4 is a timing chart illustrating the processings of saving and reading context data according to the second embodiment.

FIG. 5 is a block diagram illustrating an exemplary configuration of a semiconductor device according to a third embodiment.

FIG. 6 is a timing chart illustrating the processings of saving and reading context data according to the third embodiment.

FIG. 7 is a block diagram illustrating an exemplary configuration of a semiconductor device according to a fourth embodiment.

FIG. 8 is a timing chart for explaining processings of a register power supply controller according to the fourth embodiment.

### DETAILED DESCRIPTION

The following description and drawings are appropriately omitted or simplified for clear explanation. The same components are denoted with the same reference signs throughout each drawing, and the repetitive description thereof is omitted as needed.

### First Embodiment

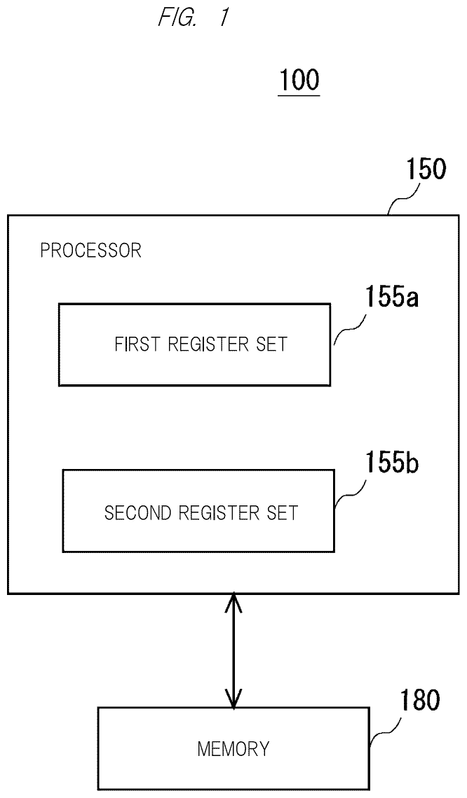

FIG. 1 illustrates an configuration of a semiconductor device 100 according to a first embodiment. As illustrated in FIG. 1, the semiconductor device 100 includes a processor 150 and a memory 180 connected to the processor 150. The memory 180 is capable of storing programs executed by the processor 150 therein. The memory 180 is usable as a storage region for storing a plurality of items of context data described later. In some embodiments, the processor 150 may adopt, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory 180 is made of, for example, a combination of a static random access memory (SRAM) and a dynamic random access memory (DRAM).

Programs stored in the memory 180 include a hypervisor and a plurality of OSs. The hypervisor is a program for controlling the virtualization environment. The processor 150 reads and executes the hypervisor from the memory 180 thereby to perform various processings for controlling the virtualization environment, such as creating and terminating a plurality of virtual machines, saving and reading context data, and selecting an active register set. When the plurality of virtual machines is created by executing the hypervisor, the virtual machines execute mutually different OSs, respectively. For example, when the OSs include a first OS and a second OS, the processor 150 executes the hypervisor thereby to create a first virtual machine which executes the first OS and a second virtual machine which executes the second OS.

The processor 150 includes a first register set 155a and a second register set 155b for use in storing context data. The context data includes various items of data associated with operation states of the processor 150, such as a value of a program counter and a value during calculation. The first register set 155a is a register set used when the processor 150 executes the hypervisor. The first register set 155a stores context data associated with an operation state of the processor 150 provided when the hypervisor is executed by the processor 150 (which will be also referred to as “first context data for execution of the hypervisor” or simply “first context data” below).

The second register set 155b is a register set used when the processor 150 executes the virtual machine. For example, when the first virtual machine and the second virtual machine are created on the virtualization environment, the second register set 155b stores context data associated with an operation state of the processor 150 provided when the first virtual machine is executed by the processor 150 (which will be also referred to as “second context data for execution of the first virtual machine” or simply “second context data” below) and context data associated with an operation state of the processor 150 provided when the second virtual machine is executed by the processor 150 (which will be also referred to as “third context data for execution of the second virtual machine” or simply “third context data” below).

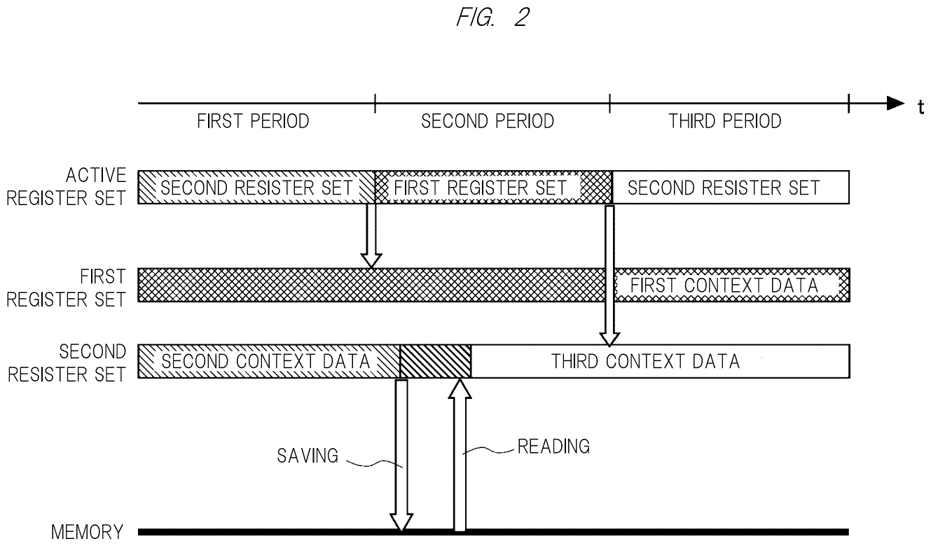

Next, processings in the switching of the virtual machine, performed by executing the hypervisor, will be described below. FIG. 2 is a timing chart illustrating the processings of saving and reading context data according to the first embodiment. The horizontal axis indicates time axis. FIG. 2 illustrates an example of switching from a state where the first virtual machine executes the first OS to a state where the second virtual machine executes the second OS.

The processor 150 executes the hypervisor in the middle of the switching of the virtual machine in order to control the switching between the first virtual machine and the second virtual machine. That is, when the first virtual machine is switched to the second virtual machine, the operation state of the processor 150 transits from a first state where the first virtual machine executes the first OS to a second state where the processor 150 executes the hypervisor, and then transits from the second state to a third state where the second virtual machine executes the second OS.

The first period to the third period depending on the operation states of the processor 150 are illustrated in the time axis as illustrated in FIG. 2. In the second period, the first register set 155a is selected as an active register set. This period is a period where the hypervisor is executed. To the contrary, the second register set 155b is selected as an active register set in the first period and the third period. These periods are periods where either the first virtual machine or the second virtual machine is executed.

In the example of FIG. 2, the virtual machine is switched from the first virtual machine (the first OS) to the second virtual machine (the second OS). Thus, the second register set 155b is capable of storing the second context data and the third context data in this order at a predetermined time interval in time axis. The time interval corresponds to the time required for the processings of saving and reading the context data for execution of the virtual machines.

The processor 150 selects the second register set 155b as an active register set in the first period. In the first period, the second context data for execution of the first virtual machine is stored into the second register set 155b. In the first period, the processor 150 executes the first OS on the first virtual machine by use of the second context data stored in the second register set 155b.

Subsequently, the processor 150 executes the hypervisor in order to switch the first virtual machine to the second virtual machine. In the second period, the processor 150 switches the state where the second register set 155b is selected as the active register set to the state where the first register set 155a is selected as the active register set. The first context data for execution of the hypervisor is stored into the first register set 155a. The processor 150 executes the hypervisor by use of the first context data stored into the first register set 155a.

In the second period, the processor 150 reads the second context data from the second register set 155b, and stores it into the memory 180. That is, the processing of saving the second context data in the memory 180 is performed. Further, the processor 150 reads the third context data for execution of the second virtual machine from the memory 180, and stores it into the second register set 155b. That is, the processing of reading the third context data from the memory 180 is performed. The third context data stored in the memory 180 is context data saved in the memory 180 such that the previous state where the second virtual machine executes the second OS can be continued again.

Subsequently, in the third period, the processor 150 switches the state where the first register set 155a is selected as the active register set to the state where the second register set 155b is selected as the active register set. The third context data for execution of the second virtual machine is stored into the second register set 155b. The processor 150 executes the second OS on the second virtual machine by use of the third context data stored in the second register set 155b.

As described above, the semiconductor device according to the first embodiment includes a plurality of register sets for storing context data. One of the register sets is used only for storing the context data for execution of the hypervisor. Therefore, the processings of saving and reading the context data for the hypervisor are not required in the switching between the state where the virtual machine is executed and the state where the hypervisor is executed. That is, it is unnecessary to consider the memory access time required for the processings of saving and reading the context data for execution of the hypervisor.

Any one of the register sets is selected as the active register set in the semiconductor device according to the first embodiment. Thus, while the processor can continue to operate by use of the context data stored in the register set selected as the active register set, the processings of saving and reading the context data can be performed to a register set not selected as the active register set until the register is selected again as a next active register set. For example, in the example of FIG. 2, the processing of saving the second context data and the processing of reading the third context data are performed in the second period in which the hypervisor is executed, in other words, in a period between the start of the second period and the start of the third period in which the second register set 155b is selected as the active register set again. Thereby, the memory access time required for the processings of saving and reading the context data for the virtual machines can be hidden. Consequently, the time to execute the OS operating on the virtual machine can be sufficiently secured, thereby improving the performance of the virtual machines.

### Second Embodiment

A second embodiment will be described below. The second embodiment is different from the first embodiment in the number of virtual machines. Not only the first virtual machine (VM1) and the second virtual machine (VM2) but also a third virtual machine (VM3) operates in a semiconductor device according to the second embodiment. The third virtual machine executes a third OS.

The first OS, the second OS, and the third OS are OSs operable on the virtual environment. Examples of the OSs are Android (registered trademark), Linux (registered trademark), UNIX (registered trademark), OS X (registered trademark), iOS (registered trademark), WINDOWS an (registered trademark), embedded operating system, and the like, but are not limited thereto. Such an OS is applicable to a vehicle-mounted system such as navigation system, air conditioner, instrument cluster, and display.

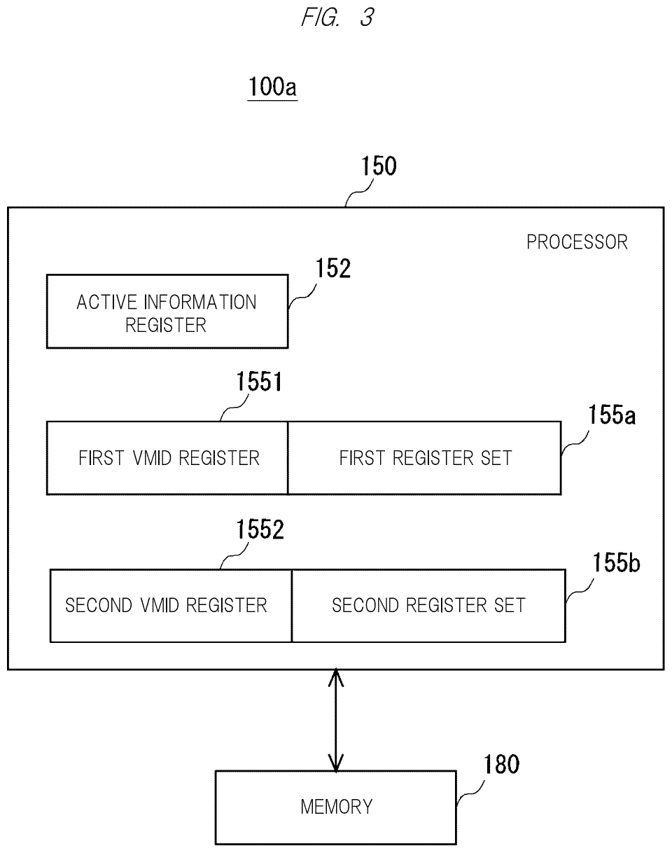

FIG. 3 is a block diagram illustrating an exemplary configuration of a semiconductor device 100a according to the second embodiment. The semiconductor device 100a is applicable for switching the OS on the virtualization environment. As illustrated in FIG. 3, the semiconductor device 100a includes the processor 150 and the memory 180 connected to the processor 150. The semiconductor device 100a may further include other components such as a network interface not illustrated. The hypervisor, the first OS, the second OS, and the third OS are stored into the memory 180. The memory 180 is applicable as a place to save the second context data, the third context data, and fourth context data described later.

The processor 150 includes an active information register 152, the first register set 155a, the second register set 155b, a first identification number (VMID) register 1551, and a second VMID register 1552. The first VMID register 1551 is installed in association with the first register set 155a. The second VMID register 1552 is installed in association with the second register set 155b.

The active information register 152 is capable of storing information indicating which one of the first register set 155a and the second register set 155b is the active register set. The first register set 155a is capable of storing the first context data for execution of the hypervisor. The second register set 155b is capable of storing any of the second context data for the first virtual machine, the third context data for the second virtual machine, and context data associated with an operation state of the processor 150 provided when the third virtual machine is executed by the processor 150 (which will be also referred to as “fourth context data for execution of the third virtual machine” or simply “fourth context data” below).

In the second embodiment, the VMIDs are used as information for identifying the hypervisor and the virtual machines. The VMID of the hypervisor is 0, for example. The VMID of the first virtual machine is 1. The VMID of the second virtual machine is 2. The VMID of the third virtual machine is 3. The first VMID register 1551 and the second VMID register 1552 store the information for specifying the hypervisor and the virtual machine associated with the context data stored in the first register set 155a and the second register set 155b by use of the VMIDs, respectively.

For example, when the first context data is stored into the first register set 155a, the first VMID register 1551 stores “VMID=0” which indicates that the context data stored in the first register set 155a is context data associated with the hypervisor. When the second context data is stored into the second register set 155b, the second VMID register 1552 stores “VMID=1” which indicates that the context data stored in the second register set 155b is context data associated with the first virtual machine.

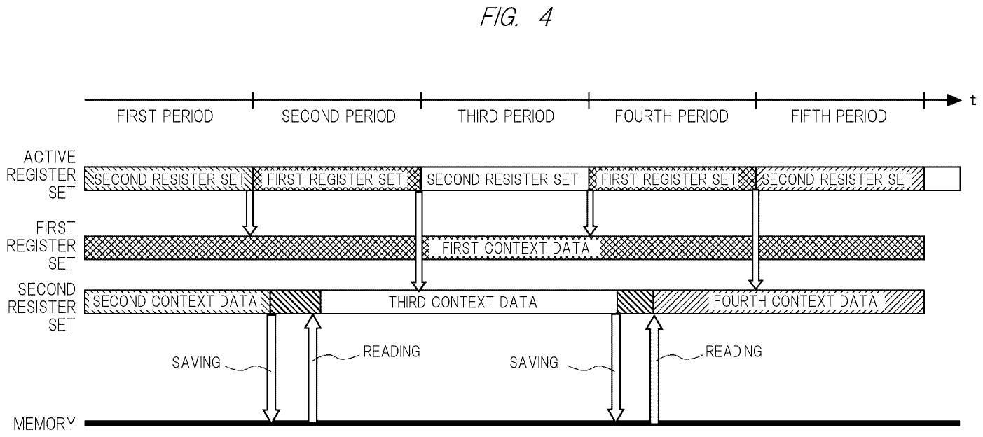

Processings performed when the virtual machine is switched by executing the hypervisor will be described below. FIG. 4 is a timing chart illustrating the processings of saving and reading context data according to the second embodiment. The horizontal axis indicates time axis. FIG. 4 illustrates an example of switching from a state where the first virtual machine executes the first OS to a state where the second virtual machine executes the second OS and subsequent switching from a state where the second virtual machine executes the second OS to a state where the third virtual machine executes the third OS.

The first period to the fifth period depending on the operation states of the processor 150 are illustrated in the time axis as illustrated in FIG. 4. In the second and fourth periods, the first register set 155a is selected as the active register set. These periods are periods where the hypervisor is executed. To the contrary, the second register set 155b is selected as the active register set in the first, third and fifth periods. These periods are periods where any of the first, second or third virtual machine is executed.

In the example of FIG. 4, the first virtual machine (the first OS), the second virtual machine (the second OS), and the third virtual machine (the third OS) are switched in this order. The second register set 155b is capable of storing the second context data, the third context data, and the fourth context data in this order at a predetermined time interval in time axis in accordance with the switching order. The time interval corresponds to the time required for the processings of saving and reading the context data for execution of the virtual machines.

In the first period to the third period, the processor 150 operates as similar to the above description in FIG. 2. Therefore, the repetitive description is omitted. However, the second embodiment is different from the first embodiment in the use of the active information register 152, the first VMID register 1551, and the second VMID register 1552.

In the first period to the third period, the first context data is stored into the first register set 155a, and thus, the processor 150 stores “VMID=0” into the first VMID register 1551. In all the periods of the second embodiment, the first context data is stored into the first register set 155a. Therefore, the first VMID register 1551 stores “VMID=0” also in and after the fourth period.

In the first period, the second context data is stored into the second register set 155b, and the second register set 155b is selected as the active register set. Therefore, in the first period, the processor 150 stores “VMID=1” into the second VMID register 1552, and stores the information indicating that the second register set 155b is the active register, into the active information register 152.

Subsequently, in the second period, the first register set 155a is selected as the active register set, and thus, the processor 150 stores the information indicating that the first register set 155a is the active register, into the active information register 152. The processings of saving and reading the context data are performed to the second register set 155b, and thus, the third context data is stored into the second register set 155b. Therefore, the processor 150 stores “VMID=2” into the second VMID register 1552.

Subsequently, in the third period, the second register set 155b is selected as the active register set, and thus, the processor 150 stores the information indicating that the second register set 155b is the active register set, into the active information register 152.

Subsequently, in the fourth period, the processor 150 executes the hypervisor again in order to switch the second virtual machine to the third virtual machine. The processor 150 stores the information indicating that the first register set 155a is the active register, into the active information register 152. Thereby, the processor 150 switches the state where the second register set 155b is selected as the active register set to the state where the first register set 155a is selected as the active register set. The processor 150 executes the hypervisor by use of the first context data stored in the first register set 155a.

The processor 150 reads the third context data from the second register set 155b, and stores it into the memory 180 in the fourth period, in other words, in a period between the start of the fourth period and the start of the fifth period in which the second register set 155b is selected as the active register set again. That is, the processing of saving the third context data in the memory 180 is performed. The processor 150 further reads the fourth context data for execution of the third virtual machine from the memory 180, and stores it into the second register set 155b. That is, the processing of reading the fourth context data from the memory 180 is performed. The fourth context data stored in the memory 180 is context data saved in the memory 180 such that the previous state in which the third virtual machine executes the third OS can be continued again. The processor 150 stores “VMID=3” into the second VMID register 1552.

Subsequently, in the fifth period, the processor 150 stores the information indicating that the second register set 155b is the active register, into the active information register 152. Thereby, the processor 150 switches the state where the first register set 155a is selected as the active register set to the state where the second register set 155b is selected as the active register set. The processor 150 executes the third OS on the third virtual machine by use of the fourth context data stored in the second register set 155b.

As described above, not only the first virtual machine and the second virtual machine but also the third virtual machine operates in the semiconductor device according to the second embodiment. That is, even if the number of virtual machines (the number of OSs) increases to three, the semiconductor device according to the second embodiment can achieve similar effects to those of the semiconductor device according to the first embodiment by performing the processings of saving and reading context data for execution of virtual machines by use of a plurality of register sets.

The semiconductor devices in which two or three virtual machines operate are described in the first embodiment and the second embodiment. However, the number of virtual machines (or the number of OSs operating on the virtual machines) is not limited thereto. The number of virtual machines may be, for example, four or more.

### Third Embodiment

A third embodiment will be described below. In the second embodiment, the exemplary semiconductor device in which three virtual machines are switched by use of two register sets has been described. In the third embodiment, a semiconductor device in which three virtual machines are switched by use of three register sets will be described. The description of the third embodiment overlapping those of the first and second embodiments will be omitted.

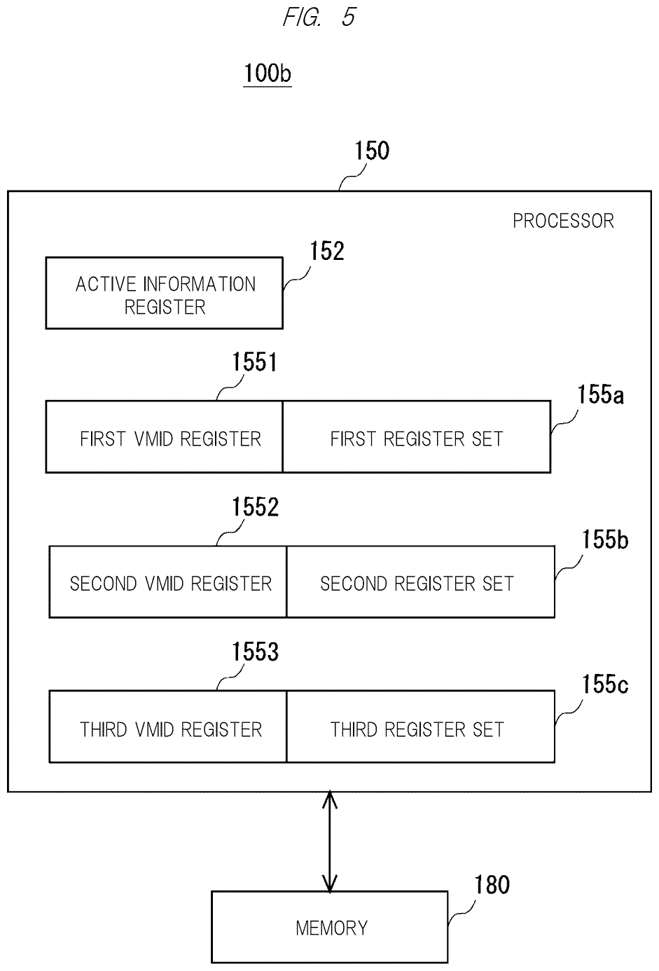

FIG. 5 is a block diagram illustrating an exemplary configuration of a semiconductor device 100b according to the third embodiment. The processor 150 in the semiconductor device 100b illustrated in FIG. 5 further includes a third register set 155c and a third VMID register 1553 in addition to the components of the processor 150 in the semiconductor device 100a illustrated in FIG. 3. The third VMID register 1553 is installed in association with the third register set 155c.

The third register set 155c is capable of storing any of the second context data for execution of the first virtual machine, the third context data for execution of the second virtual machine, and the fourth context data for execution of the third virtual machine as similar to the second register set 155b. However, the second register set 155b and the third register set 155c store mutually different context data at the same timing. For example, when the second register set 155b stores the second context data therein, the third register set 155c stores either the third context data or the fourth context data therein.

The third VMID register 1553 stores information for specifying a virtual machine associated with context data stored in the third register set 155c by use of the VMID. For example, when the second context data is stored into the third register set 155c, the third VMID register 1553 stores “VMID=1” which indicates that the context data stored in the third register set 155c is context data associated with the first virtual machine.

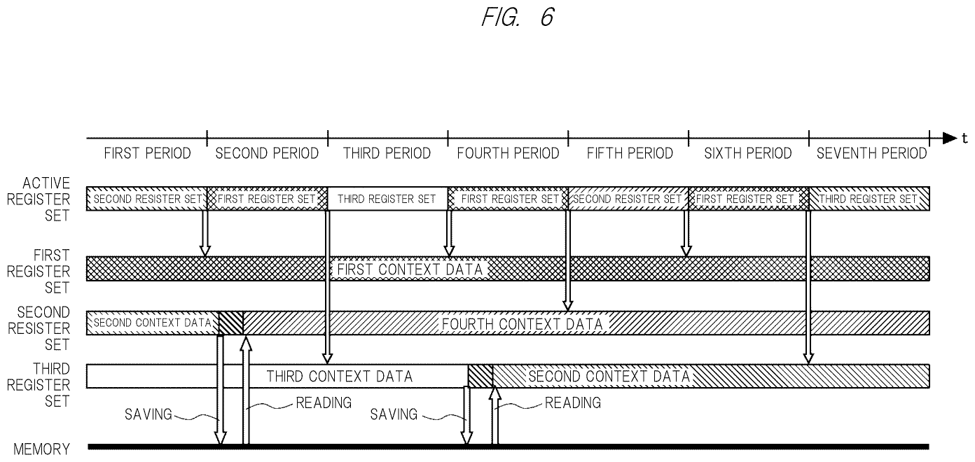

Processings performed when the virtual machine is switched by executing the hypervisor will be described below. FIG. 6 is a timing chart illustrating the processings of saving and reading context data according to the third embodiment. The horizontal axis indicates time axis. FIG. 6 illustrates an example of switching from a state where the first virtual machine executes the first OS to a state where the second virtual machine executes the second OS, subsequent switching from the state where the second virtual machine executes the second OS to a state where the third virtual machine executes the third OS and further subsequent switching from the state where the third virtual machine executes the third OS to the state where the first virtual machine executes the first OS.

The first period to the seventh period depending on the operation states of the processor 150 are illustrated in the time axis as illustrated in FIG. 6. In the second, fourth and sixth periods, the first register set 155a is selected as the active register set. These periods are periods where the hypervisor is executed. To the contrary, the second register set 155b is selected as the active register set in the first and fifth periods. Also, the third register set 155c is selected as the active register set in the third and seventh periods. The first, third, fifth and seventh periods are periods where any of the first, second or third virtual machine is executed.

In the example of FIG. 6, the first virtual machine (the first OS), the second virtual machine (the second OS), the third virtual machine (the third OS) and the first virtual machine (the first OS) are switched in this order. The second register set 155b is capable of storing the second context data, the fourth context data and the third context data in this order at a predetermined time interval in time axis in accordance with the switching order. Also, the third register set 155c is capable of storing the third context data and the second context data in this order at a predetermined time interval in time axis. The time interval corresponds to the time required for the processings of saving and reading the context data for execution of the virtual machines.

In the first period to the seventh period, the first context data is stored into the first register set 155a, and thus, the processor 150 stores “VMID=0” into the first VMID register 1551.

As illustrated in FIG. 6, the processor 150 selects the second register set 155b as the active register set in the first period. In the first period, the second context data is stored into the second register set 155b, and “VMID=1” is stored into the second VMID register 1552. In the first period, the processor 150 executes the first OS on the first virtual machine by use of the second context data stored in the second register set 155b. It is assumed in the initial state that the third context data is stored into the third register set 155c while “VMID=2” is stored into the third VMID register 1553.

Subsequently, the processor 150 executes the hypervisor in order to switch the first virtual machine to the second virtual machine. In the second period, the processor 150 switches the state where the second register set 155b is selected as the active register set to the state where the first register set 155a is selected as the active register set. The processor 150 executes the hypervisor by use of the first context data stored in the first register set 155a.

In the second period, the processor 150 reads the second context data from the second register set 155b, and stores it into the memory 180. That is, the processing of saving the second context data in the memory 180 is performed. Further, the processor 150 reads the fourth context data for execution of the third virtual machine from the memory 180, and stores it into the second register set 155b. That is, the processing of reading the fourth context data from the memory 180 is performed. The fourth context data stored in the memory 180 is context data saved in the memory 180 such that the previous state in which the third virtual machine executes the third OS can be continued again. The processor 150 stores “VMID=3” into the second VMID register 1552.

Subsequently, in the third period, the processor 150 stores the information indicating that the third register set 155c is the active register, into the active information register 152. Thereby, the processor 150 switches the state where the first register set 155a is selected as the active register set to the state where the third register set 155c is selected as the active register set. The processor 150 executes the second OS on the second virtual machine by use of the third context data stored in the third register set 155c.

Subsequently, in the fourth period, the processor 150 executes the hypervisor in order to switch the second virtual machine to the third virtual machine. The processor 150 stores the information indicating that the first register set 155a is the active register, into the active information register 152. Thereby, the processor 150 switches the state where the third register set 155c is selected as the active register set to the state where the first register set 155a is selected as the active register set. The processor 150 executes the hypervisor by use of the first context data stored in the first register set 155a.

In the fourth period, the processor 150 reads the third context data from the third register set 155c, and stores it into the memory 180. That is, the processing of saving the third context data in the memory 180 is performed. Further, the processor 150 reads the second context data for execution of the first virtual machine from the memory 180, and stores it into the third register set 155c. That is, the processing of reading the second context data from the memory 180 is performed. The second context data stored in the memory 180 is context data saved from the second register set 155b into the memory 180 in the second period. By the use of the context data, the state in which the first virtual machine executes the first OS in the processing of saving can be continued again. The processor 150 stores “VMID=1” into the third VMID register 1553.

Subsequently, in the fifth period, the processor 150 stores the information indicating that the second register set 155b is the active register, into the active information register 152. Thereby, the processor 150 switches the state where the first register set 155a is selected as the active register set to the state where the second register set 155b is selected as the active register set. The processor 150 executes the third OS on the third virtual machine by use of the fourth context data stored in the second register set 155b.

Subsequently, in the sixth period, the processor 150 executes the hypervisor in order to switch the third virtual machine to the first virtual machine. The processor 150 stores the information indicating that the first register set 155a is the active register, into the active information register 152. Thereby, the processor 150 switches the state where the second register set 155b is selected as the active register set to the state where the first register set 155a is selected as the active register set. The processor 150 executes the hypervisor by use of the first context data stored in the first register set 155a.

Subsequently, in the seventh period, the processor 150 stores the information indicating that the third register set 155c is the active register, into the active information register 152. Thereby, the processor 150 switches the state where the first register set 155a is selected as the active register set to the state where the third register set 155c is selected as the active register set. The processor 150 executes the first OS on the first virtual machine by use of the second context data stored in the third register set 155c.

As described above, the processings of saving and reading the context data for execution of the hypervisor and the three virtual machines are performed by use of the three register sets in the semiconductor device according to the third embodiment. Thereby, the third embodiment can achieve similar effects to those of the first and second embodiments.

In the third embodiment, the processings of saving and reading context data to be performed in the second period and the fourth period have been described. However, it is only necessary to perform the processings to be completed until a next virtual machine starts being executed. That is, the processing of saving the second context data and the processing of reading the fourth context data to be performed in the second period as described above may be performed between the start of the second period and the start of the fifth period in which the second register set 155b is selected as the active register set again. The processing of saving the third context data and the processing of reading the second context data to performed in the fourth period as described above may be performed between the start of the fourth period and the start of the seventh period in which the third register set 155c is selected as the active register set again.

The processings of saving and reading context data as described in the first to third embodiments can be performed by use of direct memory access (DMA) transfer. That is, when the processings of saving and reading context data are performed by executing the hypervisor, the processor 150 can instruct a DMA controller not illustrated to perform a processing of transferring context data between the register set and the memory 180. After the completion of the instruction on the transfer processing, the DMA controller can execute the transfer processing of context data irrespective of the operation state of the processor 150.

In the second embodiment, the number of register sets for use in storing the context data for execution of the virtual machine is one, and thus, the processings of saving and reading context data need to be completed in one period (in the second period or the fourth period in FIG. 4) in which the hypervisor is executed. In this case, the periods in which the hypervisor is executed (the second period and the fourth period in FIG. 4) need to be set in consideration of the time required to complete the processings of saving and reading context data, and there is a risk of influence on securement of the time to execute the OS operating on the virtual machine.

To the contrary, in the third embodiment, two register sets for use in storing the context data for execution of the virtual machines are provided. Thus, three periods (from the second period to the fourth period or from the fourth period to the sixth period in FIG. 6) are usable for the processings of saving and reading context data. In this case, the processings of saving and reading context data do not need to be completed in the period in which the hypervisor is executed, and thus, the periods in which the hypervisor is executed do not need to be prolonged in consideration of the time required to complete the processings of saving and reading context data. That is, the time to execute the OS on the virtual machine can be more easily secured with the semiconductor device according to the third embodiment than that of the semiconductor device according to the second embodiment, thereby further improving the performance of the virtual machines.

In the third embodiment, the semiconductor device in which three virtual machines are switched by use of three register sets has been described. However, the number of register sets may be four or more. When the processings of saving and reading context data for execution of virtual machines are required, note that a relation “M<N+1” is established between the number (M) of register sets and the number (N) of virtual machines (or OSs). Note that “M” and “N” are natural numbers.

### Fourth Embodiment

A fourth embodiment will be described below. A semiconductor device according to the fourth embodiment has a function to stop supplying power to a register set in a period in which the register set is not used for storing context data. In the fourth embodiment, the description overlapping those of the first to third embodiments will be omitted.

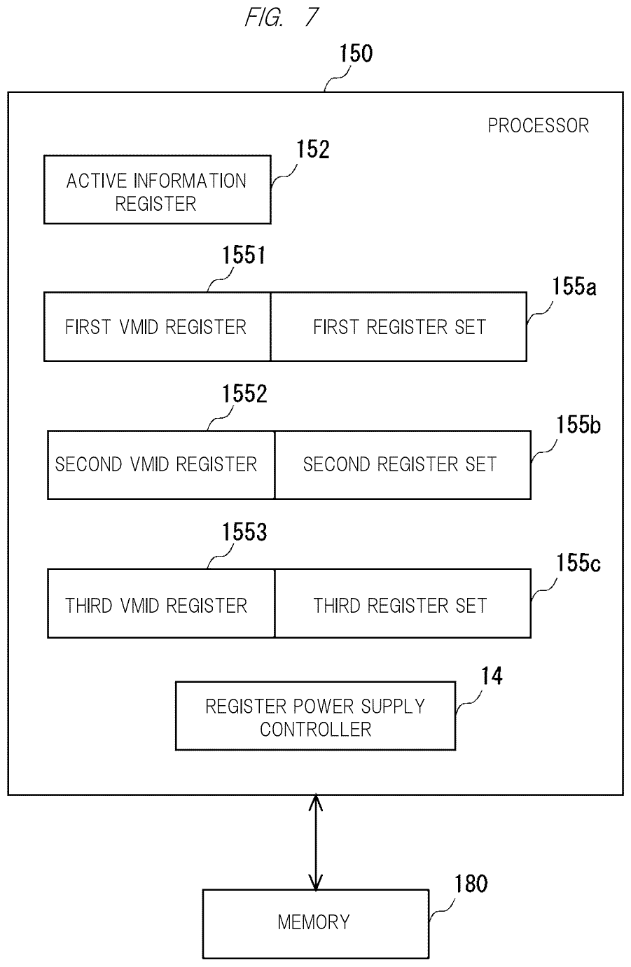

FIG. 7 is a block diagram illustrating an exemplary configuration of a semiconductor device 100c according to the fourth embodiment. The processor 150 in the semiconductor device 100c illustrated in FIG. 7 further includes a register power supply controller 14 in addition to the components of the processor 150 in the semiconductor device 100b illustrated in FIG. 5.

The register power supply controller 14 is connected to the second register set 155b, the third register set 155c, the second VMID register 1552, and the third VMID register 1553, and controls the power supply to the register sets. The processor 150 continues to supply the power to the register set storing context data used for the most recent execution of the virtual machine out of the second register set 155b and the third register set 155c and the VMID register installed in association therewith, but stops the power supply to the register set not used for the most recent execution of the virtual machine and the VMID register installed in association therewith.

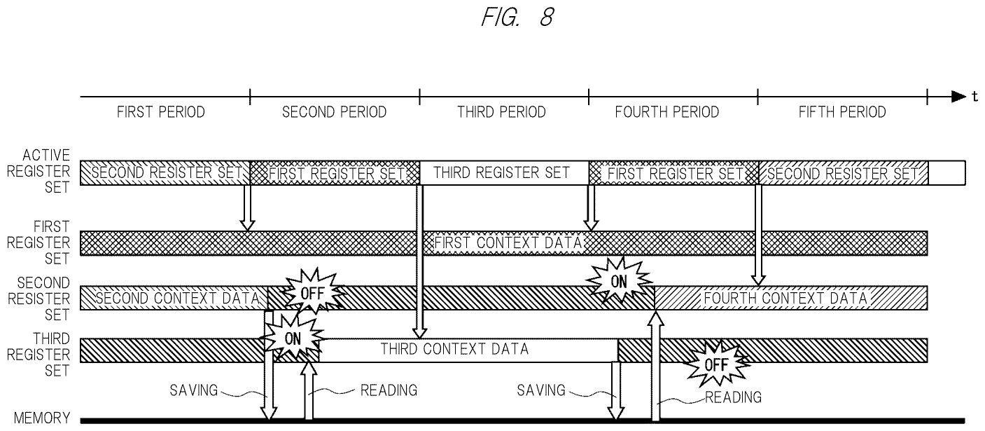

FIG. 8 is a timing chart for explaining the processings of the register power supply controller 14 according to the fourth embodiment. The horizontal axis indicates time. The processings other than the processings of controlling the power supply by the register power supply controller 14 and the processings of reading context data for execution of virtual machines among the processings illustrated in the timing chart of FIG. 8 are the same as the processings performed in the first period to the fifth period in the timing chart of FIG. 6, and thus, the repetitive description will be omitted. It is assumed in the initial state that the power supply to the third register set 155c and the third VMID register 1553 is stopped.

As illustrated in FIG. 8, in the second period and the fourth period in which the processings of saving and reading context data are executed, the register power supply controller 14 controls supplying the power to the second register set 155b, the third register set 155c, the second VMID register 1552, and the third VMID register 1553. In FIG. 8, the start of the power supply to the register set is indicated as “ON”, and the stop of the power supply to the register set is indicated as “OFF”.

In the second period, the processor 150 reads the second context data from the second register set 155b, and stores it into the memory 180. Then, the register power supply controller 14 in the processor 150 stops supplying the power to the second register set 155b for which the saving processing has been performed and to the second VMID register 1552 installed in association therewith.

In the second period, the register power supply controller 14 in the processor 150 starts supplying the power to the third register set 155c and the third VMID register 1553. Then, the processor 150 reads the third context data from the memory 180, and stores it into the third register set 155c. The processor 150 stores “VMID=2” into the third VMID register 1553.

In the fourth period, the processor 150 reads the third context data from the third register set 155c, and stores it into the memory 180. Then, the register power supply controller 14 in the processor 150 stops supplying the power to the third register set 155c for which the saving processing has been performed and to the third VMID register 1553 installed in association therewith.

In the fourth period, the register power supply controller 14 in the processor 150 restarts supplying the power to the second register set 155b and to the second VMID register 1552. Then, the processor 150 reads the fourth context data from the memory 180, and stores it into the second register set 155b. The processor 150 stores “VMID=3” into the second VMID register 1552.

As described above, in the fourth embodiment, the processing of reading context data for the register set is not continuously performed after the processing of saving context data for the register set, but is performed at a timing of elapse of predetermined time from timing of the saving processing. As illustrated in FIG. 8, for example, the processing of reading the fourth context data for the second register set 155b is performed in not the second period but the fourth period.

In the fourth embodiment, the power supply to the register set and the VMID register installed in association therewith is stopped by control of the register power supply controller 14 in a period between the processing of saving context data for the register set and the processing of reading context data for the same register set, in other words, in a period in which the register set is not used for storing context data. Thereby, the power of the semiconductor device can be saved.

In terms of the power saving, the timing for the processing of reading context data is desirably as late as possible. The processing of reading the fourth context data for the second register set 155b needs to be performed by the end of the period in which the second register set 155b is selected as the active register set again, in other words, the period between the second period and the fourth period. In this case, when the processing of reading the fourth context data is performed in, for example, not the third period but the fourth period, the time to stop the power supply to the second register set 155b can be prolonged, thereby enhancing the effect of the power saving in the semiconductor device.

The features and components of the semiconductor devices according to the first to fourth embodiments are applicable to a switching method for an operating system in the semiconductor device.

In the foregoing, the invention made by the inventors of the present application has been concretely described on the basis of the embodiments. However, the present invention is not limited to the foregoing embodiments, and various modifications can be made within the scope of the present invention.

What is claimed is:

1. A semiconductor device in which a plurality of virtual machines including a first virtual machine and a second virtual machine is operated, the first virtual machine and the second virtual machine being managed by a hypervisor, the semiconductor device comprising:
a processor including a first register set and a second register set; and
a memory configured to store the hypervisor, a first operating system executed by the first virtual machine, and a second operating system executed by the second virtual machine,
wherein the first register set is configured to store first context data associated with an operation state of the processor provided when the hypervisor is executed by the processor,
wherein the second register set is configured to store second context data associated with an operation state of the processor provided when the first virtual machine is executed by the processor or third context data associated with an operation state of the processor provided when the second virtual machine is executed by the processor, and
wherein the processor is configured to:
in a first period, select the second register set as an active register set, and execute the first operating system on the first virtual machine using the second context data stored in the second register set;
in a second period, switch a state where the second register set is selected as the active register set to a state where the first register set is selected as the active register set, and execute the hypervisor using the first context data stored in the first register set;
in a period between the start of the second period and the selection of the second register set as the active register set again, read the second context data stored in the second register set to store the read second context data into the memory, and read the third context data from the memory to store the read third context data into the second register set; and
in a third period, switch the state where the first register set is selected as the active register set to the state where the second register set is selected as the active register set, and execute the second operating system on the second virtual machine using the third context data stored in the second register set.

2. The semiconductor device according to claim 1, wherein in the second period, the processor is configured to read the second context data stored in the second register set to store the read second context data into the memory, and read the third context data from the memory to store the read third context data into the second register set.

3. The semiconductor device according to claim 1,
wherein the plurality of virtual machines further includes a third virtual machine,
wherein the processor further includes a third register set,
wherein the memory is further configured to store a third operating system executed by the third virtual machine,
wherein the third register set is configured to store the second context data, or fourth context data associated with an operation state of the processor provided when the third virtual machine is executed by the processor,
wherein the processor is configured to:
in a fourth period, switch the state where the first register set is selected as the active register set to a state where the third register set is selected as the active register set, and execute the third operating system on the third virtual machine using the fourth context data stored in the third register set;
in a fifth period, switch the state where the third register set is selected as the active register set to the state where the first register set is selected as the active register set, and execute the hypervisor using the first context data stored in the first register set; and
in a period between the start of the fifth period and the selection of the third register set as the active register set again, read the fourth context data stored in the third register set to store the read fourth context data into the memory, and read the second context data from the memory to store the read second context data into the third register set, and
wherein the fourth period and the fifth period are between the second period and the third period.

4. The semiconductor device according to claim 3, wherein in at least one of the second period, the fourth period, and the fifth period, the processor is configured to read the second context data stored in the second register set to store the read second context data into the memory, and read the third context data from the memory to store the read third context data into the second register set.

5. The semiconductor device according to claim 3,
wherein the processor is configured to:
in a sixth period, switch the state where the second register set is selected as the active register set to the state where the first register set is selected as the active register set, and execute the hypervisor using the first context data stored in the first register set; and
in a seventh period, switch the state where the first register set is selected as the active register set to the state where the third register set is selected as the active register set, and execute the first operating system on the first virtual machine using the second context data stored in the third register set, and
wherein the sixth period and the seventh period are after the third period.

6. The semiconductor device according to claim 5, wherein in at least one of the fifth period, the third period, and the sixth period, the processor is configured to read the fourth context data stored in the third register set to store the read fourth context data into the memory, and read the second context data from the memory to store the read second context data into the third register set.

7. The semiconductor device according to claim 1,
wherein the plurality of virtual machines further includes a third virtual machine and a fourth virtual machine,
wherein the processor further includes a third register set and a fourth register set,
wherein the memory is further configured to store a third operating system executed by the third virtual machine and a fourth operating system executed by the fourth virtual machine,
wherein the third register set is configured to store fourth context data associated with an operation state of the processor provided when the third virtual machine is executed by the processor, and fifth context data associated with an operation state of the processor provided when the fourth virtual machine is executed by the processor,
wherein the processor is configured to:
in a fourth period, switch the state where the first register set is selected as the active register set to a state where the third register set is selected as the active register set, and execute the third operating system on the third virtual machine using the fourth context data stored in the third register set;
in a fifth period, switch the state where the third register set is selected as the active register set to the state where the first register set is selected as the active register set, and execute the hypervisor using the first context data stored in the first register set; and
in a period between the start of the fifth period and the selection of the third register set as the active register set again, read the fourth context data stored in the third register set to store the read fourth context data into the memory, and read the fifth context data from the memory to store the read fifth context data into the third register set, and
wherein the fourth period and the fifth period are between the second period and the third period.

8. The semiconductor device according to claim 7, wherein in at least one of the second period, the fourth period, and the fifth period, the processor is configured to read the second context data stored in the second register set to store the read second context data into the memory, and read the third context data from the memory to store the read third context data into the second register set.

9. The semiconductor device according to claim 8,
wherein the processor is configured to:
in a sixth period, switch the state where the second register set is selected as the active register set to the state where the first register set is selected as the active register set, and execute the hypervisor using the first context data stored in the first register set; and
in a seventh period, switch the state where the first register set is selected as the active register set to the state where the third register set is selected as the active register set, and execute the fourth operating system on the fourth virtual machine using the fifth context data stored in the third register set, and
wherein the sixth period and the seventh period are after the third period.

10. The semiconductor device according to claim 8, wherein in at least one of the fifth period, the third period, and the sixth period, the processor is configured to read the fourth context data stored in the third register set to store the read fourth context data into the memory, and read the fifth context data from the memory to store the read fifth context data into the third register set.

11. The semiconductor device according to claim 3,
wherein the processor is configured to:
in the second period, read the second context data stored in the second register set to store the read second context data into the memory, and then, stop supplying power to the second register set; and
in the second period, start supplying power to the third register set, and read the third context data from the memory to store the read third context data into the third register set.

12. The semiconductor device according to claim 1, wherein the processor further includes an active information register configured to store information indicating which one of the first register set and the second register set is the active register set.

13. A switching method for an operating system by a semiconductor device in which a plurality of virtual machines including a first virtual machine and a second virtual machine is operated, the first virtual machine and the second virtual machine being managed by a hypervisor,
wherein the semiconductor device includes:
a processor including a first register set and a second register set; and
a memory configured to store the hypervisor, a first operating system executed by the first virtual machine, and a second operating system executed by the second virtual machine,
wherein the first register set is configured to store first context data associated with an operation state of the processor provided when the hypervisor is executed by the processor,
wherein the second register set is configured to store second context data associated with an operation state of the processor provided when the first virtual machine is executed by the processor or third context data associated with an operation state of the processor provided when the second virtual machine is executed by the processor, and
wherein the switching method comprises:
by the processor,
in a first period, selecting the second register set as an active register set, and executing the first operating system on the first virtual machine using the second context data stored in the second register set;
in a second period, switching the state where the second register set is selected as the active register set to a state where the first register set is selected as the active register set, and executing the hypervisor using the first context data stored in the first register set;
in a period between the start of the second period and the selection of the second register set as the active register set again, reading the second context data stored in the second register set to store the read second context data into the memory, and reading the third context data from the memory to store the read third context data into the second register set; and
in a third period, switching the state where the first register set is selected as the active register set to the state where the second register set is selected as the active register set, and executing the second operating system on the second virtual machine using the third context data stored in the second register set.

14. The switching method for the operating system according to claim 13, further comprising, by the processor, in the second period, reading the second context data stored in the second register set to store the read second context data into the memory, and reading the third context data from the memory to store the read third context data into the second register set.

15. The switching method for the operating system according to claim 13,
wherein the plurality of virtual machines further includes a third virtual machine,
wherein the processor further includes a third register set,
wherein the memory is further configured to store a third operating system executed by the third virtual machine,
wherein the third register set is configured to store the second context data, or fourth context data associated with an operation state of the processor provided when the third virtual machine is executed by the processor,
wherein the switching method further comprises:
by the processor,
in a fourth period, switching the state where the first register set is selected as the active register set to a state where the third register set is selected as the active register set, and executing the third operating system on the third virtual machine using the fourth context data stored in the third register set;
in a fifth period, switching the state where the third register set is selected as the active register set to the state where the first register set is selected as the active register set, and executing the hypervisor using the first context data stored in the first register set; and
in a period between the start of the fifth period and the selection of the third register set as the active register set again, reading the fourth context data stored in the third register set to store the read fourth context data into the memory, and reading the second context data from the memory to store the read second context data into the third register set, and
wherein the fourth period and the fifth period are between the second period and the third period.

16. The switching method for the operating system according to claim 15, further comprising, by the processor, in at least one of the second period, the fourth period, and the fifth period, reading the second context data stored in the second register set to store the read second context data into the memory, and reading the third context data from the memory to store the read third context data into the second register set.

17. The switching method for the operating system according to claim 15, further comprising:
by the processor,
in a sixth period, switching the state where the second register set is selected as the active register set to the state where the first register set is selected as the active register set, and executing the hypervisor by use of the first context data stored in the first register set; and
in a seventh period, switching the state where the first register set is selected as the active register set to the state where the third register set is selected as the active register set, and executing the first operating system on the first virtual machine using the second context data stored in the third register set, and
wherein the sixth period and the seventh period are after the third period.

18. The switching method for the operating system according to claim 17, further comprising, by the processor, in at least one of the fifth period, the third period, and the sixth period, reading the fourth context data stored in the third register set to store the read fourth context data into the memory, and reading the second context data from the memory to store the read second context data into the third register set.

19. The switching method for the operating system according to claim 13,
wherein the plurality of virtual machines further includes a third virtual machine and a fourth virtual machine,
wherein the processor further includes a third register set and a fourth register set,
wherein the memory is further configured to store a third operating system executed by the third virtual machine and a fourth operating system executed by the fourth virtual machine,
wherein the third register set is configured to store fourth context data associated with an operation state of the processor provided when the third virtual machine is executed by the processor, and fifth context data associated with an operation state of the processor provided when the fourth virtual machine is executed by the processor,
wherein the switching method further comprises:
by the processor,
in a fourth period, switching the state where the first register set is selected as the active register set to a state where the third register set is selected as the active register set, and executing the third operating system on the third virtual machine using the fourth context data stored in the third register set;
in a fifth period, switching the state where the third register set is selected as the active register set to the state where the first register set is selected as the active register set, and executing the hypervisor using the first context data stored in the first register set; and
in a period between the start of the fifth period and the selection of the third register set as the active register set again, reading the fourth context data stored in the third register set to store the read fourth context data into the memory, and reading the fifth context data from the memory to store the read fifth context data into the third register set, and
wherein the fourth period and the fifth period are between the second period and the third period.

20. The switching method for the operating system according to claim 19, further comprising, by the processor, in at least one of the second period, the fourth period, and the fifth period, reading the second context data stored in the second register set to store the read second context data into the memory, and reading the third context data from the memory to store the read third context data into the second register set.
